(19) United States
(12) Patent Application Publication
(10) Pub. No.: US 2023/0252450 A1
(43) Pub. Date: Aug. 10, 2023

(54) VIRTUAL CARD PAYMENTS SYSTEM

(71) Applicant: Wells Fargo Bank, N.A., San Francisco, CA (US)

(72) Inventors: Geri Loukas de Anda, San Francisco, CA (US); Christine N. Hunsucker, Loveland, CO (US); Brenda Leigh Gordon, Frisco, TX (US)

(21) Appl. No.: 17/143,038

(22) Filed: Jan. 6, 2021

Related U.S. Application Data
(60) Provisional application No. 63/077,295, filed on Sep. 11, 2020.

(51) Int. Cl. G06Q 20/34; G06Q 20/38; G06Q 20/14

(52) U.S. Cl. CPC G06Q 20/351; G06Q 20/382; G06Q 20/348; G06Q 20/14

(57) ABSTRACT

Techniques are described for providing a virtual card payments system that enables commercial customers to make business-to-business (B2B) payments via a virtual credit card number without exposing an originating account to a payment recipient. A commercial customer may submit bill information for one or more invoices to the virtual card payments system. The virtual card payments system sends a request to a credit account number server for generation of a virtual credit card number that is associated with the commercial customer's originating account for each submitted invoice. The virtual credit card number may then be sent to a recipient via a secure channel to perform payment of the invoice without exposing the originating account to the recipient. The virtual card payments system may send the virtual credit card number to the recipient or directly to the recipient's merchant acquirer to process payment of the invoice.

This application claims the benefit of U.S. Provisional Patent Application No. 63/077,295, filed on Sep. 11, 2020, the entire content of which is incorporated herein by reference.

### TECHNICAL FIELD

The invention relates to secure processing of financial data.

### BACKGROUND

Business-to-business (B2B) payments (e.g., invoice payments) between a customer and one or more recipients are typically managed through the use of individual lines of credit with each of the recipients, paper checks written from the customer's business checking account at a financial institution, and/or a commercial credit card issued by the customer's financial institution.

### SUMMARY

In general, this disclosure describes techniques for providing a virtual card payments system that enables commercial customers to make business-to-business (B2B) payments via a virtual credit card number without exposing an originating account to a payment recipient. A commercial customer may submit payments (i.e., bill information for one or more invoices) to the virtual card payments system through files, real-time web services, or directly from a virtual card payments system front-end application. The virtual card payments system sends a request to a credit account number (CAN) server for generation of a virtual credit card number that is associated with the commercial customer's originating account for each submitted invoice. The virtual credit card number may then be sent to a recipient via a secure channel to perform payment of the invoice without exposing the originating account to the recipient. As one example, the virtual card payments system may send the virtual credit card number to the recipient via secure email for payment of an invoice. As another example, the virtual card payments system may perform straight-through-processing (STP) in which the virtual credit card number is pushed directly to the recipient's merchant acquirer to process payment of the invoice and an email alert is sent to the recipient with invoice payment details.

The requested virtual credit card numbers may be single-use numbers that may be used once for an exact dollar amount of the payment and, in some examples, only during a specific date range and/or only for the specific recipient. The virtual credit card numbers for a given commercial customer may be associated with one or more of the commercial customer's originating accounts at a financial institution. In some examples, the originating accounts may comprise commercial credit card accounts and/or business checking accounts. Upon receipt of bill information for invoices from the commercial customer, the virtual card payments system may identify one or more invoices of a given recipient and may determine a preferred payment file format of the recipient. The virtual card payments system may then generate a batch payment collection and processing file in the recipient's preferred format that includes the virtual credit card numbers generated for the submitted invoices of the recipient along with any additional payment details of the submitted invoices. The recipient may then retrieve the batch payment collection and processing file from the virtual card payments system through secure document delivery (e.g., secure email) or through secure file transfer, and process payment of each of the invoices included in the batch payment collection and processing file.

Traditional processes for managing B2B payments may require significant amounts of time and paperwork. For example, a commercial customer may need to maintain separate lines of credit with each of the recipients or use paper checks to make invoice payments. Commercial credit cards may provide commercial customers with a convenient and economic payment option with recipients that accept commercial credit cards. The commercial credit cards, however, present similar security risks as traditional credit cards, including risks associated with providing the same card number and credentials to multiple recipients and risks associated with manual entry errors when keying in payments.

The virtual card payments system described in this disclosure enables management of B2B payments through the use of a unique virtual credit card number generated for each invoice that may increase control and reduce fraud. The virtual credit card number is linked to the commercial customer's originating account, but can be sent to recipients and/or merchant acquirers to process payment of the invoice without exposing the originating account number. The virtual credit card number may include controls regarding amount, date range, and/or recipient to ensure use for payment of the corresponding invoice. The virtual credit card number may be single-use such that the card number is no longer valid once the corresponding payment is processed for the exact dollar amount of the invoice payment. In addition, the disclosed virtual card payments system provides flexible payment workflows including payment options using application programming interfaces (APIs), secure email, or secure file transfer. The flexible payment workflows may include the automatic creation of a batch payment collection and processing file in the recipient's preferred format that may manage the unique virtual credit card numbers generated for the invoices of the recipient and avoid manual credit card number entry by the recipient or, in some cases, the commercial customer.

The disclosed virtual card payments system includes a user interface dashboard through which the commercial customer may view transaction exceptions, required payment repairs, and real-time credit information, which may make it easier for the commercial customer to prioritize payments and other actions. The disclosed virtual card payments system also provides the option of a straight-through-processing (STP) service with the advantage of not waiting for recipients to process the commercial customer's payments. With the STP service, the commercial customer may initiate a payment of an invoice directly with the recipient's merchant acquirer. The recipient's merchant acquirer then authorizes the payment and deposits the funds directly into the recipient's account. The STP service may give the commercial customer more control over payment timing and further streamline processing and reconciliation.

In one example, this disclosure is directed to a method comprising receiving, by a computing system and from a customer device, bill information for one or more invoices of at least one recipient to be paid by a customer associated with the customer device; sending, by the computing system and to a credit account number server, a request for generation of a virtual credit card number associated an originating account of the customer for each invoice of the one or more invoices; and transmitting, by the computing system, the virtual credit card number and payment details for each invoice of the one or more invoices via secure channels for payment of the one or more invoices of the at least one recipient without exposing the originating account of the customer.

In another example, this disclosure is directed to a computing system comprising one or more interfaces, and one or more processors in communication with the one or more interfaces. The one or more processors are configured to receive, from a customer device, bill information for one or more invoices of at least one recipient to be paid by a customer associated with the customer device; send, to a credit account number server, a request for generation of a virtual credit card number associated an originating account of the customer for each invoice of the one or more invoices; and transmit the virtual credit card number and payment details for each invoice of the one or more invoices via secure channels for payment of the one or more invoices of the at least one recipient without exposing the originating account of the customer.

In a further example, this disclosure is directed to a non-transitory computer-readable storage medium comprising instructions that, when executed, cause one or more processors to receive, from a customer device, bill information for one or more invoices of at least one recipient to be paid by a customer associated with the customer device; send, to a credit account number server, a request for generation of a virtual credit card number associated an originating account of the customer for each invoice of the one or more invoices; and transmit the virtual credit card number and payment details for each invoice of the one or more invoices via secure channels for payment of the one or more invoices of the at least one recipient without exposing the originating account of the customer.

The details of one or more examples of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example network system that includes a virtual card payments application, in accordance with the techniques of this disclosure.

FIG. 2 is a block diagram illustrating the virtual card payments application from FIG. 1 in further detail.

FIG. 3 is a flow chart illustrating example payment routing options provided by the virtual card payments application, in accordance with the techniques of this disclosure.

FIG. 4 is a flow chart illustrating an example batch payment collection and processing file creation process provided by the virtual card payments application, in accordance with the techniques of this disclosure.

FIGS. 5A-5G illustrate example dashboard user interfaces generated by the virtual card payments application for display on a customer device, in accordance with the techniques of this disclosure.

FIG. 6 is a flow chart illustrating an example operation of managing invoice payments by a virtual card payments application, in accordance with the techniques of this disclosure.

### DETAILED DESCRIPTION

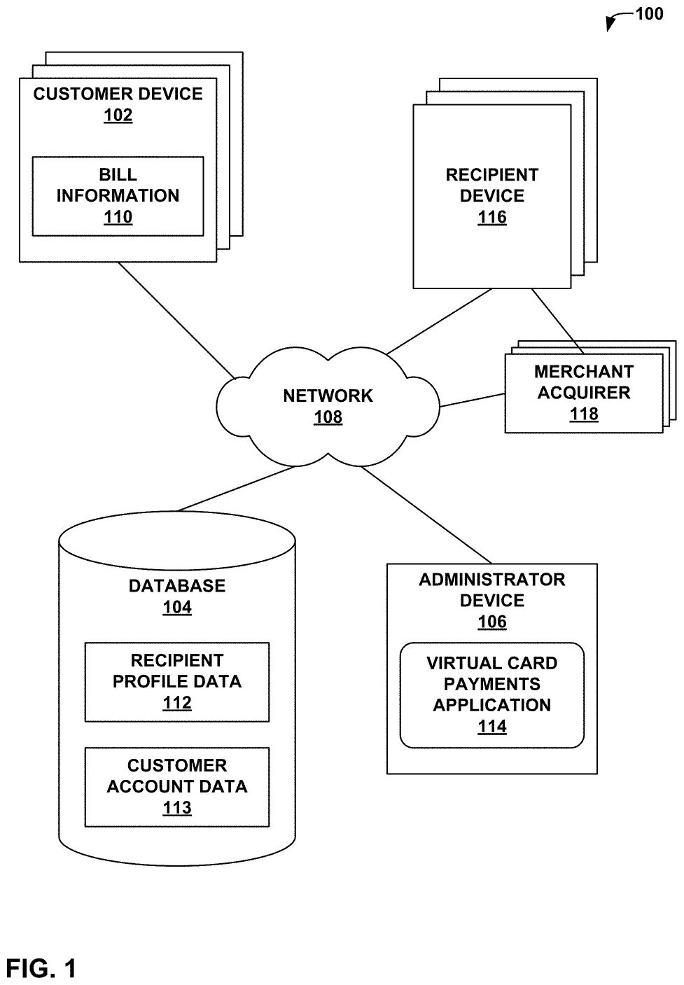

FIG. 1 is a block diagram illustrating an example network system 100 that includes a virtual card payments application 114, in accordance with the techniques of this disclosure. In the illustrated example, network system 100 includes administrator device 106, database 104, one or more customer devices 102, one or more recipient devices 116, and one or more merchant acquirers 118 in communication with each other via network 108. Customer device 102 may include bill information 110, which may include information regarding a bill, invoice, or other payable received by a customer from a recipient. Database 104 may include recipient profile data 112 and customer account data 113. In accordance with the disclosed techniques, administrator device 106 includes virtual card payments application 114.

Network 108 may comprise a private network including, for example, a private network associated with a financial institution, or may comprise a public network, such as the Internet. Although illustrated as a single entity, network 108 may comprise a combination of networks. Customer devices 102 may be one or more computing devices associated with one or more customers of a financial institution. Customer devices 102 may include one or more computing devices including, for example, one or more desktop computers, laptop computers, workstations, and/or wireless devices such as wireless “smart” phones or tablets capable of exchange data via network 108. Customer devices 102 may be configured to store bill information 110 associated with a customer and one or more recipients of the customer.

A recipient of the customer may generally refer to an entity that sells goods and/or services to the customer. For example, customer device 102 may receive a bill, invoice, or other payable from the recipient in exchange for the goods and/or services provided to the customer. Customer device 102 includes the payment details for any outstanding invoices from the one or more recipients in bill information 110. The payment details for an invoice may include a recipient or merchant identifier (ID), an invoice ID, an indication of the goods and/or services, an amount due, a payment date, and the like. In accordance with the disclosed techniques, customer device 102 is configured to transmit bill information 110 to administrator device 106 associated with the financial institution for payment to the one or more recipients via virtual card payments application 114.

Database 104 may be a data structure for storing data related to network system 100 including recipient profile data 112 and customer account data 113. Database 104 may be stored by any suitable party and in any suitable location according to particular needs. For example, database 104 may be stored and maintained by the financial institution associated with administrator device 106 or by a third-party vendor that stores and maintains data. Although illustrated as a single database 104, any suitable number of databases may be used for storing the data described according to particular needs. Although shown as being separate from administrator device 106, in certain examples, database 104 may be stored and executed within administrator device 106.

Recipient profile data 112 may include an industry type of one or more recipients. For example, for a given recipient, an industry type may be “office supplies,” “grocery store,” “industrial materials,” “technical support services,” or any other suitable industry type. Recipient profile data 112 may additionally include contact information for one or more recipients and/or one or more merchant acquirers 118 for the recipients. Merchant acquirer 118 may be a bank service provider or settlement bank that manages electronic deposits of funds from customers paid to a merchant account. Recipient profile data 112 may further include preferred payment file format information of one or more recipients. For example, for a given recipient, a preferred payment file format may be one of a set of standard payment file format templates or a custom payment file format template. Recipient profile data 112 may include information for recipients of a particular customer and/or for recipients of multiple customers.

Customer account data 113 may include one or more account types held by one or more customers at the financial institution. For example, for a given customer of the financial institution, an account type may be “line of credit,” “commercial credit,” “business checking,” or any other suitable account type. In some examples, customer account data 113 may additionally include specific account numbers associated with the one or more account types held by one or more customers. For example, for a given customer of the financial institution, customer account data 113 may include at least one of a commercial credit card account number or a business checking account number as an originating account used for payment of invoices to the one or more recipients via virtual card payments application 114.

Administrator device 106 may be associated with a financial institution including, for example a traditional bank, credit union, and/or credit card company with the capability to maintain line of credit, commercial credit, and/or business checking accounts. Administrator device 106 may be a centralized computing device configured to execute virtual card payments application 114 that enables commercial customers to make business-to-business (B2B) payments, e.g., between a commercial customer and one or more recipients, via a virtual credit card number without exposing an originating account to a payment recipient. Administrator device 106 may comprise a cluster of one or more computers, workstations, servers, and the like. Administrator device 106 configured to execute virtual card payments application 114 may be physically or virtually included within an internal network of the financial institution. Alternatively, administrator device 106 configured to execute virtual card payments application 114 may be physically or virtually included in a network hosted by a third-party vendor. For example, a vendor of the financial institution may store and maintain virtual card payments application 114 for the financial institution and/or may provide the functions of virtual card payments application 114 as a service to the financial institution.

Administrator device 106 may include one or more interfaces for allowing virtual card payments application 114 to communicate with one or more databases (e.g., database 104), devices (e.g., customer devices 102 and recipient devices 116) and/or systems (e.g., merchant acquirer systems 118) via one or more networks, e.g. network 108. The one or more interfaces may include one or more network interface cards, such as Ethernet cards, and/or any other type of device that can send and receive information. In some examples, virtual card payments application 114 utilizes the one or more interfaces to communicate with customer devices 102, database 104, recipient devices 116, merchant acquirer systems 118, and/or any other suitable device or system. Any suitable number of interfaces may be used to perform the described functions according to particular needs.

Administrator device 106 may include one or more processors configured to implement functionality and/or process instructions for execution within virtual card payments application 114. The processors may include, for example, microprocessors, digital signal processors (DSPs), application specific integrated circuits (ASICs), field-programmable gate array (FPGAs), and/or equivalent discrete or integrated logic circuitry.

Administrator device 106 may include memory configured to store information within administrator device 106. The memory may include a computer-readable storage medium or computer-readable storage device. In some examples, the memory may include one or more of a short-term memory or a long-term memory. The memory may include, for example, random access memories (RAM), dynamic random access memories (DRAM), static random access memories (SRAM), magnetic hard discs, optical discs, floppy discs, flash memories, or forms of electrically programmable memories (EPROM), or electrically erasable and programmable memories (EEPROM). In some examples, the memory may store logic (e.g., virtual card payments application 114) for execution by one or more processors. The memory may be used by virtual card payments application 114 to temporarily store information during program execution.

Customer devices 102, administrator device 106, recipient devices 116, and/or any other suitable devices for participation in the virtual card payments system may include one or more displays for displaying a user interface dashboard, e.g., a graphical user interface (GUI), that may allow a user to interact with the devices by display of graphical icons and visual indicators. For example, displays of customer devices 102 may present one or more GUIs through which commercial customers may view payments made on their behalf to one or more recipients via virtual card payments application 114. In some scenarios, the GUIs may display transaction exceptions, required payment repairs, and real-time credit information to the commercial customers, which may make it easier for the commercial customers to prioritize payments and other actions. In certain examples, any of the displays may be a touch sensitive screen and may present one or more touch sensitive GUI elements. For example, a user may be able to interact with a display to respond to options displayed on the display and initiate an action by touching one or more of the touch sensitive GUI elements displayed on the display. For example, the display may be a presence-sensitive display that displays a GUI and receives input from a user using capacitive, inductive, and/or optical detection at or near the presence sensitive display. Alternatively, or in addition, a user may be able to interact with a device to respond to options displayed on the display and initiate an action by using any suitable input device such as, for example, a keyboard, touchpad, and/or any other suitable input device. A display may comprise a cathode ray tube (CRT) monitor, a liquid crystal display (LCD), organic light emitting diode (OLED), or any other type of display device that can generate intelligible output to a user.

Virtual card payments application 114 may include instructions executed by a processor to perform the functions of virtual card payments application 114 as described herein. Virtual card payments application 114 may include instructions for sending a request to a credit account number (CAN) server (not shown in FIG. 1) for generation of a virtual credit card number that is associated with a given commercial customer's originating account for each submitted invoice, and sending the virtual credit card number to a recipient via a secure channel based on information retrieved from customer devices 102, database 104, and/or any other suitable information.

Virtual card payments application 114 may access, via network 108, bill information 110. For example, administrator device 106 may include one or more interfaces and may receive or retrieve bill information 110 by the one or more interfaces and from one or more sources, e.g., customer device 102. Virtual card payments application 114 may also access, via network 108, recipient profile data 112 and/or customer account data 113. For example, administrator device 106 may receive or retrieve recipient profile data 112 by the one or more interfaces and from one or more sources, e.g., database 104. Administrator device 106 may also receive or retrieve customer account data 113 by the one or more interfaces and from one or more sources, e.g., database 104.

In operation, according to aspects of this disclosure, virtual card payments application 114 enables a commercial customer associated with customer device 102 to make payments to one or more recipients associated with recipient devices 116 via a virtual credit card number without exposing an originating account of the commercial customer to the recipients. The commercial customer may submit payments (i.e., bill information 110 for one or more invoices) from customer device 102 to virtual card payments application 114 executing on administrator device 106 through files, real-time web services, or directly from a virtual card payments front-end application. Virtual card payments application 114 sends a request to the CAN server for generation of a virtual credit card number that is associated with the commercial customer's originating account (e.g., retrieved from customer account data 113 stored in database 104) for each submitted invoice included in bill information 110. Virtual card payments application 114 may cause administrator device 106 to send the virtual credit card number to the one of recipient devices 116 associated with the recipient to be paid via a secure channel. In this way, virtual card payments application 114 performs the payment between the commercial customer and the recipient without exposing the originating account to the recipient. As one example, virtual card payments application 114 may send the virtual credit card number to the one of recipient devices 116 associated with the recipient via secure email for payment of an invoice. As another example, virtual card payments application 114 may perform straight-through-processing (STP) in which the virtual credit card number is pushed directly to merchant acquirer 118 to process payment of the invoice and an email alert is sent to the one of recipient devices 116 associated with the recipient within invoice payment details. Virtual card payments application 114 may retrieve the recipient's contact information and/or the recipient's merchant acquirer's contact information from recipient profile data 112 stored in database 104.

The requested virtual credit card numbers may be single-use numbers that may be used once for an exact amount of the invoice. In other scenarios, the virtual credit card numbers may be multi-use numbers that may be used multiple times for multiple payments up to a predetermined amount each, but not to exceed the exact amount of the invoice. In still other scenarios, the virtual credit card numbers may be multi-use numbers that may be used multiple times for payment of multiple invoices including payment of an exact amount of a first invoice and payment of a second invoice up to an exact amount of the second invoice. In some examples, the virtual credit card numbers may be used only during a specific date range and/or only for the specific recipient (e.g., based on recipient merchant ID or merchant category code). The virtual credit card numbers for a given commercial customer may be associated with one or more of the commercial customer's originating accounts retrieved by virtual card payments application 114 from customer account data 113 stored in database 104.

Based on bill information 110 received from customer device 102 associated with the commercial customer, virtual card payments application 114 may identify one or more invoices of a given recipient and may determine a preferred payment file format of the recipient (e.g., retrieved from recipient profile data 112 stored in database 104). Virtual card payments application 114 may then generate a batch payment collection and processing file in the recipient's preferred format that includes the virtual credit card numbers generated for the submitted invoices of the recipient included in bill information 110 along with any additional payment details of the submitted invoices. The one of recipient devices 116 associated with the given recipient may then retrieve the batch payment collection and processing file from virtual card payments application 114 through secure document delivery (e.g., secure email) or through secure file transfer, and process payment of each of the invoices included in the batch payment collection and processing file.

Traditional processes for managing B2B payments may require significant amounts of time and paperwork. For example, a commercial customer may need to maintain separate lines of credit with each of the recipients or use paper checks to make invoice payments. Commercial credit cards may provide commercial customers with a convenient and economic payment option with recipients that accept commercial credit cards. The commercial credit cards, however, present similar security risks as traditional credit cards, including risks associated with providing the same card number and credentials to multiple recipients and risks associated with manual entry errors when keying in payments.

The disclosed techniques may provide a technical solution to the above described issues arising from traditional B2B payment management and processing solutions, including electronic payment solutions using commercial credit cards. Virtual card payments application 114 described in this disclosure enables management of B2B payments through the use of a unique virtual credit card number generated for each invoice payment that may increase control and reduce fraud. The generated virtual credit card number is linked to the commercial customer's originating account, but can be sent to recipient devices 116 and/or merchant acquirers 118 to process invoice payments without exposing the originating account number. The virtual credit card number may include controls regarding amount, date range, and/or recipient to ensure use for the corresponding payment. The virtual credit card number may be single-use such that the card number is no longer valid once the corresponding payment is processed for the exact payment amount. Virtual card payments application 114 disclosed herein also provides flexible payment workflows including payment options using application programming interfaces (APIs), secure email, or secure file transfer. The flexible payment workflows may include the automatic creation of a batch payment collection and processing file in the recipient's preferred format that may manage the unique virtual credit card numbers generated for the invoices of the recipient and avoid manual credit card number entry by the recipient or, in some cases, the commercial customer.

Virtual card payments application 114 disclosed herein further includes a user interface dashboard for display on customer device 102 through which the associated commercial customer may view transaction exceptions, required payment repairs, and real-time credit information, which may make it easier for the commercial customer to prioritize payments and other actions. Virtual card payments application 114 also provides the option of a straight-through-processing (STP) service with the advantage of not waiting for recipients to process the commercial customer's invoice payments. With the STP service, the commercial customer may initiate a payment directly with the recipient's merchant acquirer 118. The recipient's merchant acquirer 118 then authorizes the payment and deposits the funds directly into the recipient's account. The STP service may give the commercial customer more control over payment timing and further streamline processing and reconciliation.

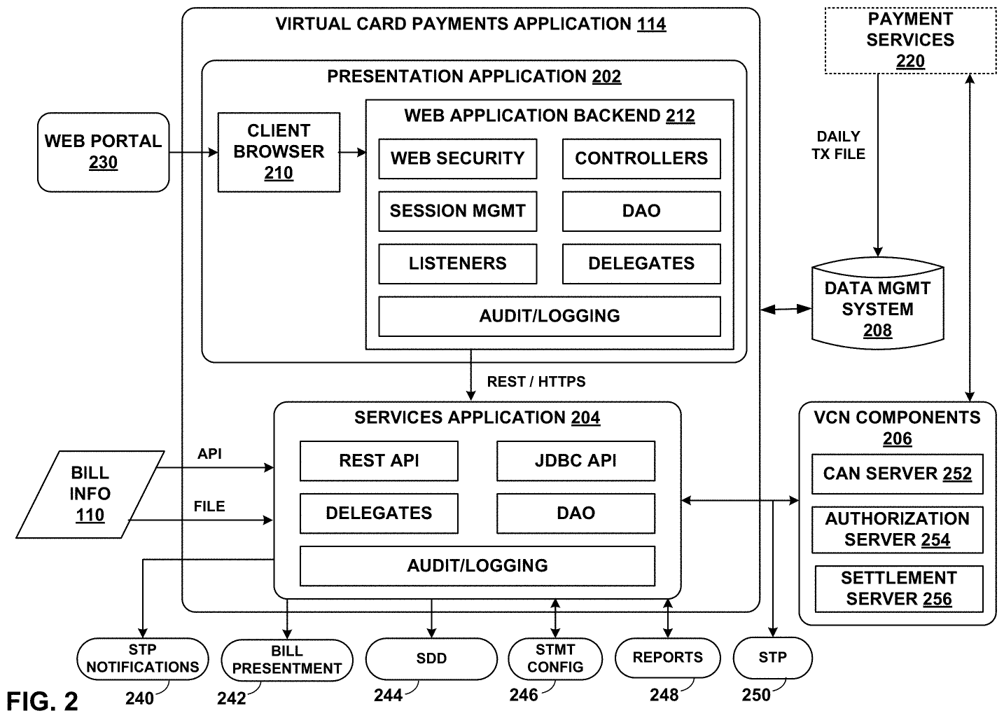

FIG. 2 is a block diagram illustrating the virtual card payments (VCP) application 114 from FIG. 1 in further detail. VCP application 114 provides customers having commercial credit card accounts and/or business checking accounts with the ability to use their commercial card or business checking as a safe and reliable option when settling accounts payable invoices with recipients.

VCP application 114 requests generation of virtual credit card numbers (e.g., 16-digit numbers) associated with customers' originating accounts that can be sent to the recipients via secure channels without exposing the originating accounts. The recipients then use the virtual credit card numbers to collect the funds. VCP application 114 enables the customers to submit bill information 110 through files, real-time web services, or directly from a VCP front-end application. In some examples, VCP application 114 may request, direct, or instruct components within a same virtual card payments system to generate the virtual credit card numbers or may request, direct, or instruct another, external system to generate the virtual credit card numbers. In the example illustrated in FIG. 2, VCP application 114 sends requests to CAN server 252 of virtual card number (VCN) components 206 within the same virtual card payments system for generation of the virtual credit card numbers.

In the example of FIG. 2, VCP application 114 includes components of a presentation application 202 configured to generate data representative of dashboard user interfaces to customer devices 102. Presentation application 202 may adhere to modern web 2.0 standards with user facing requirements being serviced by a client browser 210 (i.e., a front-end web application) that pulls data from a web application backend 212 on the server side. Commercial customers may interact with the dashboard user interfaces upon obtaining access to VCP application 114 from a web portal 230 to client browser 210. In the illustrated example of FIG. 2, web application backend 212 includes multiple functional units including a web security unit, a session management unit, a data access object (DAO) abstract interface, listeners, controllers, delegates, and an audit or logging unit.

In the example of FIG. 2, VCP application 114 also includes components of a services application 204 configured to provide business services to the commercial customers. The business service layer may expose services that cater to other channels, including presentation application 202 and API integrations with customer devices 102 and recipient devices 116. According to the disclosed techniques, services application 204 may manage receipt or retrieval of bill information 110 from customer devices 102 via secure channels (e.g., secure email file or API), requests for generation of virtual credit card numbers for invoices included in bill information 110, and transmission of the virtual credit card numbers via secure channels (e.g., secure email, secure file transfer, or API) for invoice payment processing. Services application 204 may further provide batch payment processing capability and execute virtual credit card number payments. All operational data required for services application 204 may be stored and managed in a VCP application specific schema within data management system database 208. In addition to pulling data from the VCP application specific schema in data management system database 208, services application 204 may also access VCN components 206 tasked with generating the virtual credit card numbers to gather other relevant payment information. In the illustrated example of FIG. 2, services application 204 includes multiple functional units including a REST (Representational State Transfer) API, a JDBC (Java Database Connectivity) API, a DAO abstract interface, delegates, and an audit or logging unit.

VCN components 206 include CAN server 252, authorization server 254, and settlement server 256. CAN server 252 is configured to manage the virtual credit card numbers associated with the customers' originating accounts, including generating, updating, and/or canceling the virtual credit card numbers. VCN components 206 may be third-party components that are housed within the virtual card payments system. In other examples, VCN components 206 may be included in an external, third-party system. As illustrated in FIG. 2, VCN components 206 have connectivity to payment services 220, which may be an external, third-party system (as indicated by the dotted line outline in FIG. 2). Authorization server 254 is configured to perform authorization of the virtual credit card numbers with payment services 220 and settlement server 256 is configured to perform settlement of the virtual credit card numbers with payment services 220. Payment services 220 provides new card information and a daily transaction (TX) file that includes VCP application data. The daily TX file may be stored in data management system database 208. For example, a given customer's originating account may comprise a commercial credit card account having an Originating Account Number (OAN) received from payment services 220 via a new card order process. Any VCP transactions performed using virtual credit card numbers associated with the OAN may be included in the daily TX file recorded against the OAN. Services application 204 may use the VCP transactions recorded against the OAN to create customer billing data.

All external customers may access VCP application 114 from the web portal to the client browser using their credentials, e.g., via single sign-on (SSO). Customers may be authenticated against a WAS (Wholesale Authentication Service). Upon successful login, customers having the correct product entitlement may be able to access VCP application 114 from the web portal. The presentation application of VCP application 114 may receive customer details as part of the login request and may provide the correct authorizations to the user within the application.

Customer devices 102 may include VCP instructions as part of a larger consolidated payment file sent to VCP application 114 as part of bill information 110. Bill information 110, including the payment file, may be received by services application 204 of VCP application 114 via secure channels (e.g., secure email or API). In some examples, a payment management application (not shown) may initially receive bill information 110, including the payment file, from the customer device 102 and construct a new file by isolating the VCP instructions and then sending the new file to services application 204 of VCP application 114. In either scenario, services application 204 of VCP application 114 may receive, validate, and process the file via batch processing. VCP application 114 may build a confirmation file with payment status information that is sent back to customer device 102 via the same secure channel on which bill information 110 was submitted.

As discussed above, services application 204 of VCP application 114 may be exposed to the customers via an API gateway channel. The API gateway channel may offer several advantages: customer onboarding and setup streamlined and more efficient; API contract delivery more streamlined; security setups more streamlined; and test environment/sandbox available to customers as they work through their integration.

VCP application 114 may support a straight-through-processing (STP) service 250 for performing STP payments where the remittance to the recipient is instantaneously authorized and processed by VCP application 114 with the recipient's merchant acquirer 118 on behalf of the recipient. STP service 250 may be different than VCP instructions where the virtual credit card number is sent to a recipient device 116 of the recipient via other channels, e.g., secure email, and then needs to be manually submitted by the recipient for authorization and processing. VCP application 114 may identify customers for which STP service 250 is applicable. If the corresponding recipients also accept STP service 250, then VCP application 114 may process payments between the participating customers and recipients via STP service 250. STP service 250 may leverage a third-party API associated with a payment processing service to process STP payments. The STP payments may be processed in real-time via the third-party API. VCP application 114 may support a STP notifications service 240 for sending STP notifications to recipient device 116 of the recipient that do not include the full virtual credit card number. In some instances, the STP notifications may include a last four digits of the virtual credit card number.

With the exception of STP payments, as discussed above, VCP remittance details may be sent to a recipient device 116 of the recipient via a secure document delivery (SDD) service 244. SDD service 244 sends (e.g., via secure email) the remittance details to recipient device 116 including the virtual credit card number and payment details for each invoice of the recipient without exposing the customer's originating account.

In addition to sending remittances, SDD service 244 supported by VCP application 114 may call a web service to retrieve delivery status for the secure email messages. In accordance with the disclosed techniques, SDD service 244 may include enhanced bounce back email functionality. For example, SDD service 244 may provide one or more of the following features: ability to limit or filter data returned by the web service by date range (e.g., ‘from’ input created date ‘to’ current date); ability to receive a reject reason from the web service; ability to display the reject reason in reports and dashboard user interfaces; and ability to include the reject reason in notifications sent to communicate that the recipient email address has bounced back. Example reject reasons that may be returned from the web service include: an incorrect email address, an email address missing in the recipient profile, access denied to the email address, a full mailbox for the email address, an invalid email address format, a changed email address, an unknown host address, a disabled email account, an unknown email address, and the like. The reject reason may be not be available from the web service when the reject reason is due to a mail server rejecting a message due to a spam filter; the reject reason may instead be blank or null. SDD service 244 may map the reject reason provided from the web service, including the blank or null reject reason, to a user friendly reason to display in reports and/or dashboard user interfaces.

VCP application 114 may support a bill presentment service 242 for sending or presenting, to a customer, a statement of billing data for the VCP transactions associated with the customer's originating account. Bill presentment to the customer may be done via several channels. Services application 204 of VCP application 114 may receive VCP transaction data for the customer via the daily TX file stored in data management system database 208. In addition, VCP application 114 may support a statement configuration service 246 for retrieving statement configuration information for the customer and customer payment data (e.g., from customer profile data 113 in database 104 from FIG. 1). Statement configuration service 246 may use the VCP transaction data and the retrieved statement configuration information to process final billing statements for the customer. VCP application 114 may also support a reports service 248 for providing reports to the customer in response to a request, e.g., via the front-end web application, or in response to certain predefined events. Custom reporting requirements may be serviced via a custom data solution (CDS) system.

API communication between VCP application 114 and participant systems may be secured with strong IP filter or mutually authenticated secure sockets layer (MASSL). In cases where a customer sends a payment file to VCP application 114, the payment file may be received via a secure file transfer service (e.g., SAFE-T). In general, inbound/outbound file transmission will be handled by secure file transfer. The following options are available for connecting to the secure file transfer service: hypertext transfer protocol over SSL (HTTPS) with user ID, password, and digital certificate; file transfer protocol over SSL (FTP/S) with user ID, password, and digital certificate for authentication; secure FTP (S-FTP) with user ID and key for authentication; secure FTP (S-FTP) with user ID and password for authentication; FTP with PGP (Pretty Good Privacy) with user ID and password for authentication (requires files to be PGP-encrypted); or applicability statement 2 (AS2) with user ID, password, and digital certificate for authentication. User access into VCP application 114 may be restricted to the web portal 230 channel, which may authenticate and allow SSO via WAS policies.

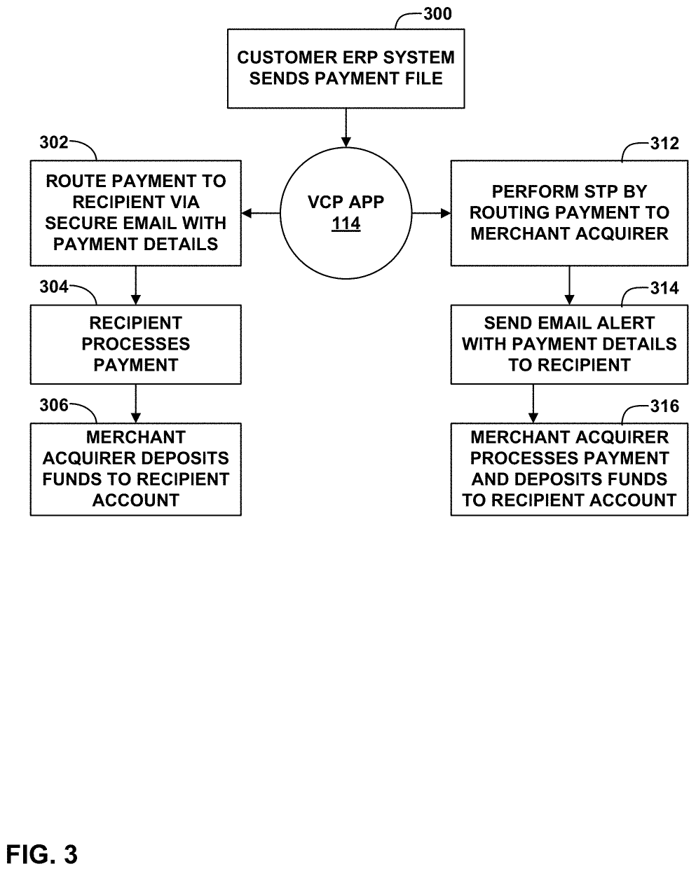

FIG. 3 is a flow chart illustrating example payment routing options provided by virtual card payments (VCP) application 114, in accordance with the techniques of this disclosure. In the example illustrated in FIG. 3, a commercial customer's enterprise resource planning (ERP) system sends a payment file (e.g., bill information 110 from FIG. 1) to VCP application 114 (300). The ERP system may comprise any business process management software system used by the commercial customer to manage bills, invoices, or other payables received by the commercial customer from one or more recipients. As described above, VCP application 114 requests generation of a unique virtual credit card number for each payment included in the payment file. Based on predetermined business rules set up during implementation by the commercial customer, VCP application 114 either routes the respective payment to the recipient via a secure email with payment details (302) or performs straight-through-processing (STP) by routing the respective payment to the recipient's merchant acquirer (312).

In the case where VCP application 114 routes the payment to the recipient (302), the recipient receives the secure email with the payment details, including the virtual credit card number generated for the payment. The recipient then processes the payment like any other credit card payment (304), and the recipient's merchant acquirer deposits the funds into the recipient's bank account (306). This payment process may be referred to as “recipient-initiated” payments because the recipient is responsible for using the virtual credit card number received from VCP application 114 to complete the payment.

In the case of STP, where VCP application 114 routes the payment to the recipient's merchant acquirer (312), VCP application 114 also sends an email alert with payment details to the recipient to notify the recipient that a new payment has been initiated (314). VCP application 114 also sends an email alert with the payment details to a third-party payment processing service. The recipient's merchant acquirer processes the payment based on the payment details, including the virtual credit card number generated for the payment, and deposits the funds into the recipient's bank account (316). This payment process may be referred to as “customer-initiated” payments because the customer, via VCP application 114, sends the virtual credit card number to the recipient's merchant acquirer and authorizes the transaction on the recipient's behalf, while the recipient never touches the payment.

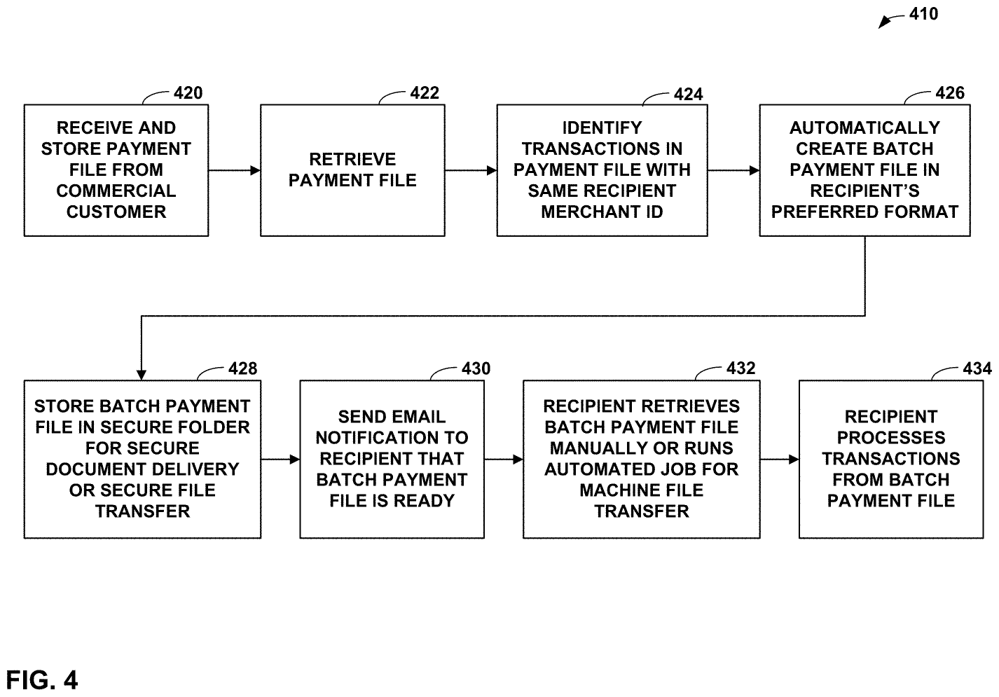

FIG. 4 is a flow chart illustrating an example batch payment collection and processing file creation process 410 provided by VCP application 114, in accordance with the techniques of this disclosure. Although primarily described herein as being performed by VCP application 114, in some other examples portions of the batch payment collection and processing file creation process 410 may be performed by another system (e.g., a custom data solution (CDS) system) under the direction of VCP application 114.

Traditionally, when a recipient requires commercial credit card remittance in a customized way (e.g., with a specific payment file format), commercial customers may utilize a proxy payment service to perform manual commercial card payments that accommodate the requirements of the recipient. An example customer-driven process for a proxy pay recipient that requires a specific payment file format may proceed as follows: (1) a customer uses its internal accounts payable (AP) department email address in its own payment file transmitted to VCP application 114, (2) the customer's AP department receives a secure document delivery (SDD) email from VCP application 114, (3) the customer's AP department logs into a SDD portal to open the secure email, (4) the customer's AP department pulls the virtual credit card number generated for the payment from the SDD email, (5) the customer's AP department logs into a payment portal of the proxy pay recipient, and (6) the customer's AP department enters the virtual credit card number and then the proxy pay recipient processes in their preferred format.

According to the disclosed techniques, VCP application 114 may provide and/or access an automated proxy pay solution. The automated proxy pay solution described herein accommodates the custom needs of key recipients, integrates into an existing payment file, protects customers from risks associated with providing credentials and card numbers to recipients and third-party vendors, and protects customers from risks of manual errors with keying in payments.

An example automated proxy pay solution for a proxy pay recipient that requires a specific payment file format is described with respect to the batch payment collection and processing file creation process 410 illustrated in FIG. 4. First, VCP application 114 receives and stores a payment file (e.g., bill information 110 from FIG. 1) from a commercial customer (420). VCP application 114 and/or the CDS system retrieves the payment file for processing and identifies transactions in the payment file that have the same recipient merchant ID (422). In some examples, the transactions may be identified as those transactions having no specified email address but having a recipient merchant ID that is on a known proxy pay recipient list (424). VCP application 114 and/or the CDS system automatically creates a batch payment collection and processing file in the identified recipient's preferred payment file format (e.g., retrieved from recipient profile data 112 stored in database 104 from FIG. 1) (426). The recipient's preferred payment file format may be one of a set of standard payment file format templates or a custom payment file format template.

VCP application 114 and/or the CDS system stores the batch payment collection and processing file in a secure folder for delivery via SDD email or secure file transfer (428). VCP application 114 sends an email notification to the proxy pay recipient that a batch payment collection and processing file is ready (430). The proxy pay recipient retrieves the batch payment collection and processing file manually or runs an automated job for a machine file transfer (432). The recipient then processes the transactions included in the batch payment collection and processing file and relieves the invoices in the payment file (434).

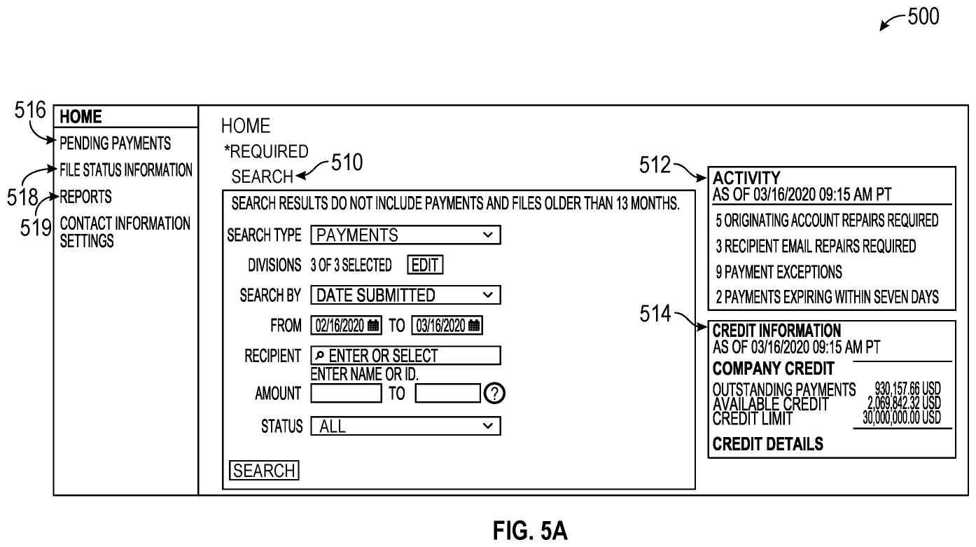

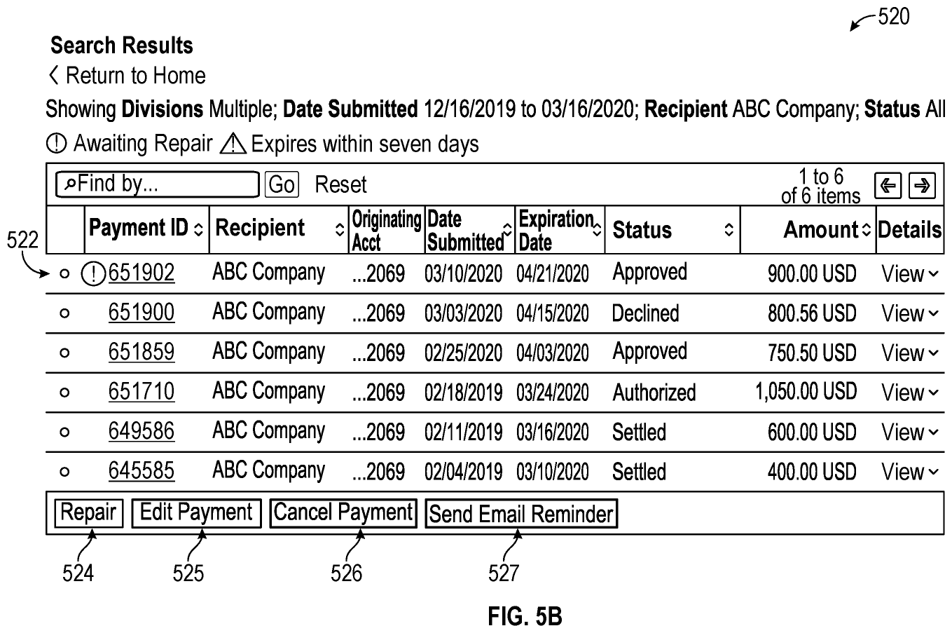

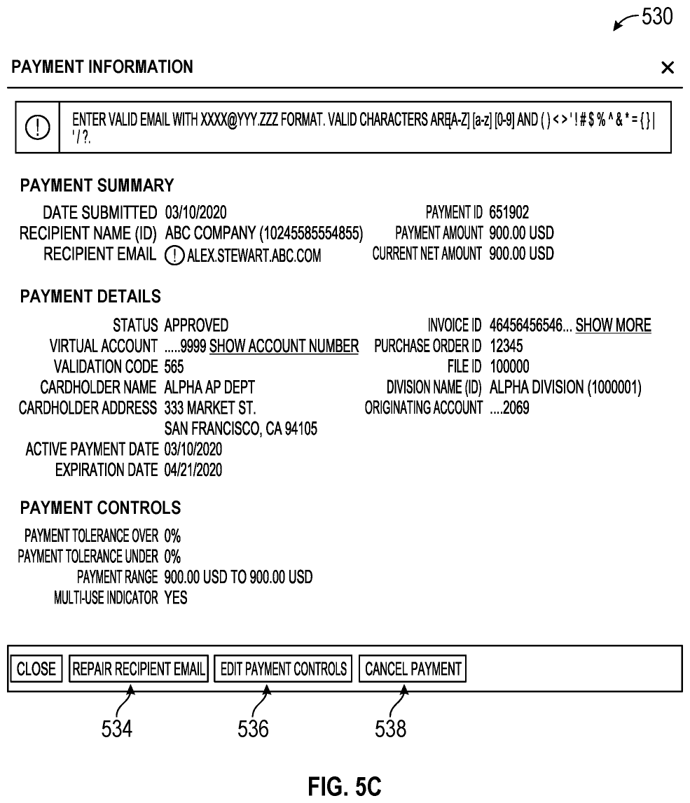

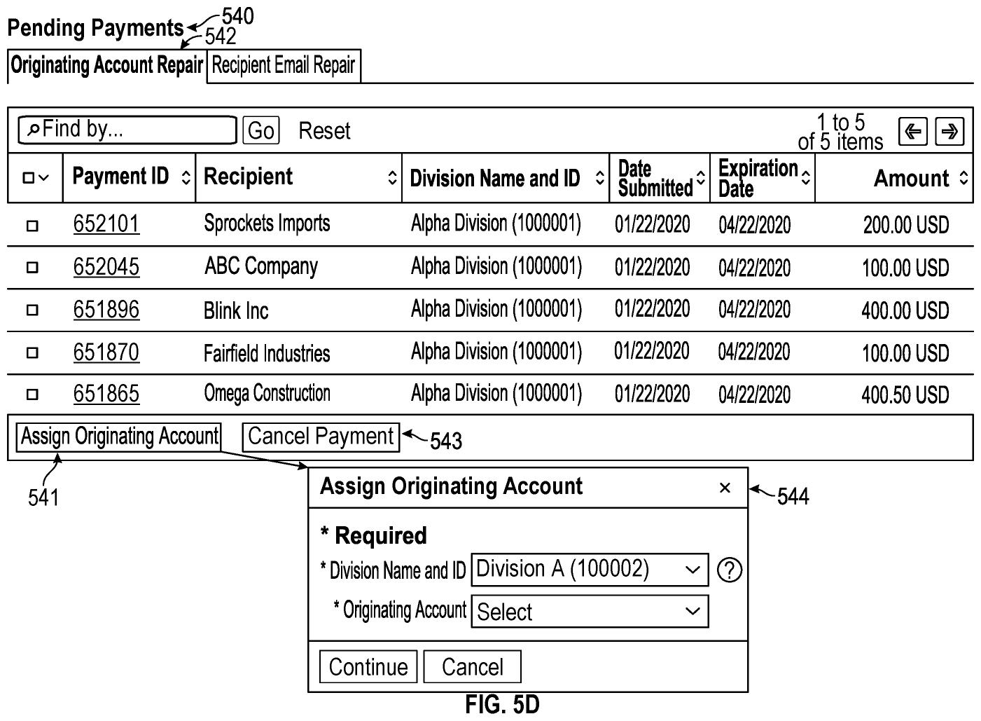

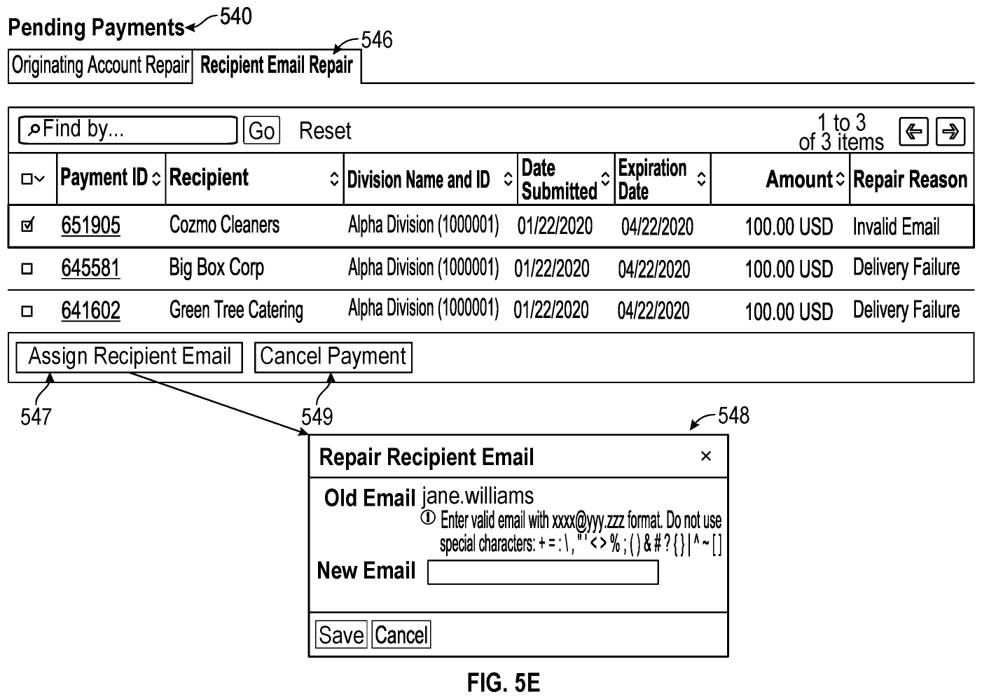

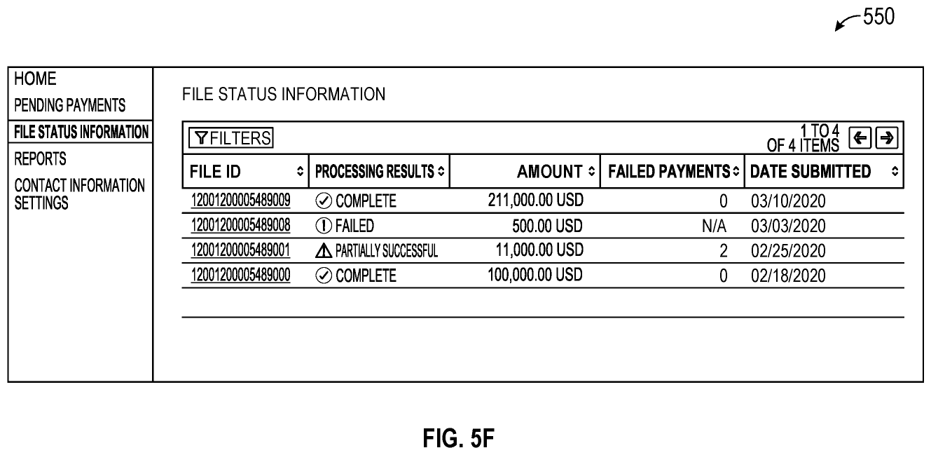

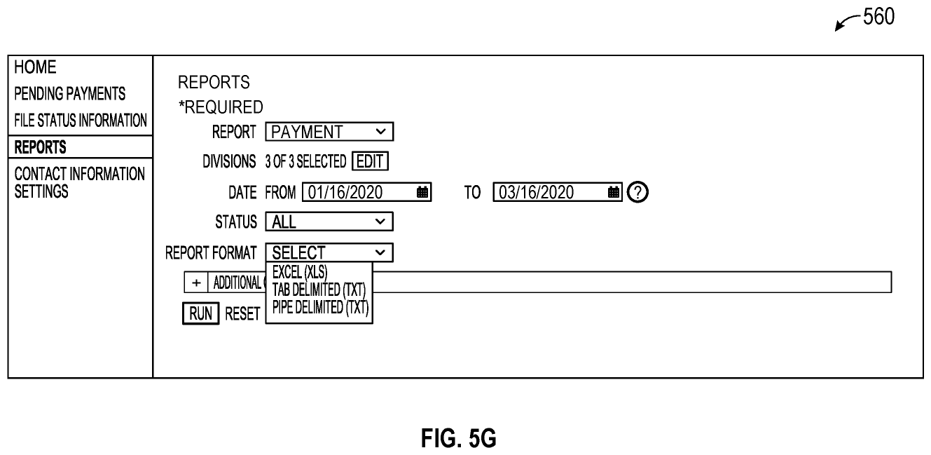

FIGS. 5A-5G illustrate example dashboard user interfaces generated by virtual card payments application 114 for display on customer devices (e.g., customer device 102 of FIG. 1), in accordance with the techniques of this disclosure. The dashboard user interfaces for virtual card payments application 114 may provide potential benefits to commercial customers, such as dashboard alerts, the ability to add and update contact information of recipients, improved payment search functionality, reporting via Microsoft™ Excel, increased reporting timeframe, and payee contact information and authentication questions displayed to the customers.

FIG. 5A illustrates an example “home” user interface 500 with a payment search feature 510, an activity dashboard 512, and a credit information dashboard 514. In addition, in the illustrated example of FIG. 5A, the user interface 500 includes a navigation bar along the left-hand side with a pending payments tab 516, a file status information tab 518, a reports tab 519, and a contact information settings tab. The contact information settings tab enables a commercial customer interacting with the user interface to manage contacts for email addresses displayed to recipients, file processing notification email alerts, and payment exception notification email alerts.

Payment search feature 510 includes fillable fields with which a commercial customer may define the bounds of the search. For example, the commercial customer may search payments or files in all divisions or by each division of the company separately. Payment search feature 510 includes options to search by date submitted (as illustrated), expiration date, transaction ID, or invoice number. In the example illustrated in FIG. 5A, payment search feature 510 further includes the search filters of date range, recipient name or recipient ID, amount range, and payment status.

Activity dashboard 512 provides a real-time snapshot of the commercial customer's payment activity including any originating account repairs, recipient email repairs, payment exceptions, and payments expiring. The “originating account repairs required” link indicates a number of payments associated with missing or invalid originating accounts. The “recipient email repairs required” link indicates a number of payments with missing email addresses, invalid email addresses, or invalid email address format for the intended recipient. The “payment exceptions” link indicates a number of payments for which processing exceptions have occurred. The “payments expiring within seven days” link indicates a number of payments for which an expiration date is approaching. The links in activity dashboard 512 may be active and, upon selection, bring the commercial customer interacting with activity dashboard 512 to a separate user interface for the topic of the selected link.

Credit information dashboard 514 provides a real-time snapshot of the commercial customer's credit associated with its originating accounts. Credit information dashboard 514 may include “outstanding payments” indicating a total amount of created payments that are not yet authorized along with the customer's current “available credit,” and a total “credit limit.” Although illustrated in FIG. 5A as presenting “company credit” information, the commercial customer may modify the credit information dashboard 514 to present credit information at the division level within the company. Credit information dashboard 514 may allow for commercial customers to easily identify issues with credit availability.

FIG. 5B illustrates an example “search results” user interface 520 with a list of payments that satisfy the search criteria. In the illustrated example of FIG. 5B, the search criteria include payments in all divisions by date submitted within the date range of Dec. 12, 2019 to Mar. 16, 2020 to recipient “ABC company.” For each payment that satisfies the search criteria, user interface 520 presents the payment ID, the recipient name, the commercial customer's originating account number, the date submitted, the expiration date, the status, the amount, and details in a drop-down menu. The details drop-down menu may include a payment information option that links to basic payment details of the respective payment, an audit history option that links to an audit history screen of the respective payment, and/or a remittance PDF option. The audit history screen (not shown) may provide customer-passed recipient authentication codes, audit details of customer-initiated updates to a payment including email and payment controls.

In the illustrated example of FIG. 5B, the user interface 520 includes a navigation bar along the bottom with a repair button 524, an edit payment button 525, a cancel payment button 526, and a send email reminder button 527. The repair button 524 may include an assign originating account option if a selected payment has an invalid or missing originating account in the inbound file, and may include a repair recipient email option if the selected payment has an invalid or missing recipient email in the inbound file. The edit payment button 525 may include an edit recipient email option that allows the customer to update a recipient email address for a selected payment, and may include an edit payment controls option that allows the customer to edit payment settings for the selected payment. The editable payment settings may include payment range settings and an indication of whether a virtual credit card number generated for the selected payment is a one time-use card number for the exact amount of the payment or a multi-use card number not to exceed the exact amount of the payment.

In the illustrated example of FIG. 5B, user interface 520 indicates that payment 522 is awaiting repair using a symbol of an exclamation point within a circle. User interface 520 may further indicate any payments that are expiring within seven days using a symbol of an exclamation point within a triangle. The payment ID link and/or payment information link under the details column of user interface 520 may be active and, upon selection, bring the commercial customer interacting with search results user interface 520 to a separate user interface for the selected payment.

FIG. 5C illustrates an example “payment information” user interface 530 for payment 522 from FIG. 5B that is awaiting repair. Payment information user interface 530 may be the user interface presented upon selection of the payment ID or payment information link associated with payment 522 from FIG. 5B. Payment information user interface 530 presents a payment summary, payment details, and payment controls information for the selected payment 522. Payment 522 includes an invalid recipient email address as indicated by the symbol of the exclamation point within the circle. In the illustrated example of FIG. 5C, the user interface 530 includes a navigation bar along the bottom with a repair recipient email button 534, an edit payment controls button 536, and a cancel payment button 538. The commercial customer interacting with user interface 530 may repair the recipient email address of payment 522 by selecting the repair recipient email button 534 and entering a valid email address of the recipient in a Tillable field (not shown).

FIGS. 5D and 5E each illustrates an example “pending payments” user interface 540. Pending payments user interface 540 may be the user interface presented upon selection of the pending payments tab 516 from FIG. 5A. Pending payments user interface 540 enables a commercial customer interacting with the user interface to fix issues with payments, including invalid originating accounts and/or recipient email addresses.

FIG. 5D illustrates an example “originating account repair” tab 542 of pending payments user interface 540. Originating account repair tab 542 includes a list of all pending payments for which the originating account needs to be repaired before the payment can be processed. In the illustrated example of FIG. 5D, the user interface tab 542 includes a navigation bar along the bottom with an assign originating account button 541 and a cancel payment button 543. The commercial customer interacting with user interface tab 542 may repair the originating account for the selected payments by selecting the assign originating account button 541 and entering a valid originating account in a resulting assign originating account pop-up window 544.

FIG. 5E illustrates an example “recipient email repair” tab 546 of pending payments user interface 540. Recipient email repair tab 546 includes a list of all pending payments for which the recipient email needs to be repaired before the payment can be processed. In the illustrated example of FIG. 5E, the user interface tab 546 includes a navigation bar along the bottom with repair recipient email button 547 and a cancel payment button 549. The commercial customer interacting with user interface tab 546 may repair the recipient email for the selected payments by selecting the repair recipient email button 547 and entering a valid email address in a resulting repair recipient email pop-up window 548.

FIG. 5F illustrates an example “file status information” user interface 550. File status information user interface 550 may be the user interface presented upon selection of the file status information tab 518 from FIG. 5A. File status information user interface 550 enables a commercial customer interacting with the user interface to review processing status by file. In the illustrated example of FIG. 5F, file status information user interface 550 includes a list of payment files by file ID and, for each payment file, indicates processing results, amount, a number of failed payments, and a date submitted. The processing results field indicates whether payments of a given payment file are complete, partially successful, or failed. In the case where payments of a payment file have been partially successful, the user interface may indicate a number of failed payments of the payment file.

FIG. 5G illustrates an example “reports” user interface 560. Reports user interface 560 may be the user interface presented upon selection of the reports tab 519 from FIG. 5A. Reports user interface 560 enables a commercial customer interacting with the user interface to access reports for virtual card activity. Reports user interface 560 includes fillable fields with which a commercial customer may define the bounds of the report. For example, the commercial customer may select a type of report, such as a payment report, settlement report, payment exception report, or a cancelled payment report. The commercial customer may request the report to be run for all divisions or by each division of the company separately. In the example illustrated in FIG. 5G, reports user interface 560 further includes report filters of date range and payment status. The commercial customer may further select a format of the requested report, such as Microsoft™ Excel, tab delimited, or pipe delimited.

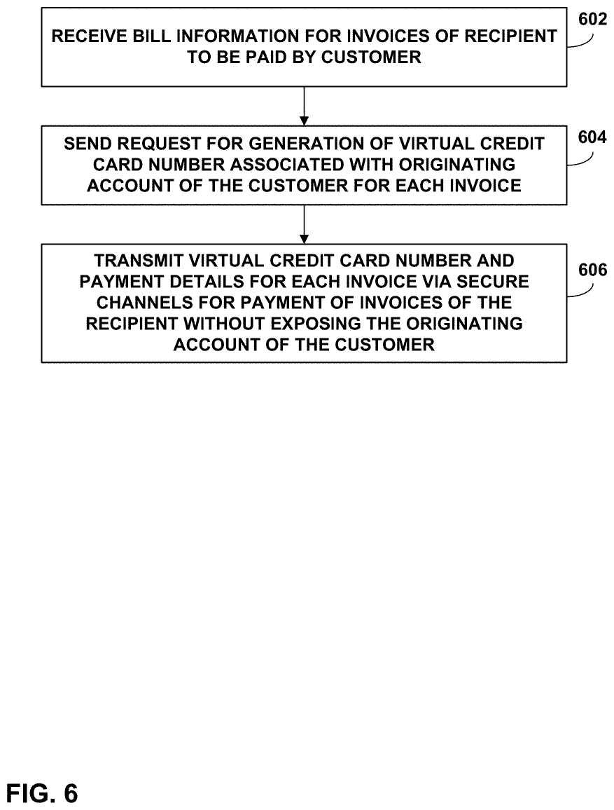

FIG. 6 is a flow chart illustrating an example operation of managing invoice payments by a virtual card payments application, in accordance with the techniques of this disclosure. The example operation of FIG. 6 is described herein with respect to VCP application 114 of FIGS. 1 and 2.

VCP application 114 receives, from a customer device (e.g., customer device 102 of FIG. 1), bill information 110 for one or more invoices of at least one recipient to be paid by a customer associated with customer device 102 (602). VCP application 114 may receive bill information 110 for the invoices from customer device 102 via one of a secure email or an API. VCP application 114 sends, to a credit account number server (e.g., CAN server 252 of FIG. 2), a request for generation of a virtual credit card number associated an originating account of the customer for each invoice of the one or more invoices (604). The originating account of the customer (e.g., retrieved from customer account data 113 stored in database 104 of FIG. 1) may comprise a commercial credit card account, a business checking account, or a line of credit account.

In one example, for a respective invoice, VCP application 114 sends a request for generation of a single-use number that is valid for only one payment of an exact amount of the respective invoice. In another example, for a respective invoice, VCP application 114 sends a request for generation of a multi-use number that is valid for two or more payments, each up to a predetermined amount, of an exact amount of the respective invoice. In a further example, for a respective invoice, VCP application 114 sends a request for generation of a multi-use number that is valid for one payment of the exact amount of the respective invoice and at least one other payment of another invoice up to an exact amount of the other invoice. In still another example, for a respective invoice, VCP application 114 sends a request for generation of a virtual credit card number that is only valid for an exact amount of the respective invoice, during a specific date range, and for a specific recipient associated with the respective invoice.

In the example of batch processing, upon generation of the virtual credit card number for each invoice in a batch of invoices of the recipient, VCP application 114 determines a preferred payment file format of the recipient (e.g., retrieved from recipient profile data 112 stored in database 104 of FIG. 1) and automatically creates a batch payment collection and processing file in the preferred payment file format of the recipient. The batch payment collection and processing file includes the virtual credit card number and payment details for each invoice in the batch of invoices of the respective recipient. VCP application 114 may then send, to recipient device 106 of the respective recipient, a message that the batch payment collection and processing file is available for retrieval via one of the secure channels.

VCP application 114 transmits the virtual credit card number and payment details for each invoice of the one or more invoices via secure channels for payment of the invoices of the at least one recipient without exposing the originating account of the customer (606). The secure channels may comprise one or more of secure email, secure file transfer, or APIs.

In one example, VCP application 114 transmits the virtual credit card number and payment details for a respective invoice to a recipient device (e.g., recipient device 106 of FIG. 1) of the recipient. In this example, recipient device 106 processes the payment of the respective invoice and the recipient's merchant acquirer (e.g., merchant acquirer 118 of FIG. 1) deposits funds into the one recipient's bank account. In another example, VCP application 114 performs STP and transmits the virtual credit card number and payment details for a respective invoice directly to the recipient's merchant acquirer 118. In this example, merchant acquirer 118 processes the payment of the respective invoice and deposits funds into the recipient's bank account. In this example, VCP application 114 also sends a message to recipient device 116 of the recipient indicating that the payment has occurred.

In some scenarios, VCP application 114 also sends, to the customer device 102, data representative of dashboard user interfaces (e.g., user interfaces 500, 520, 530, 540, 550, 560 of FIGS. 5A-5G) for presentation on customer device 102. For example, VCP application 114 may receive input from the customer associated with customer device 102 via the dashboard user interfaces to correct at least one of the originating account of the customer or contact information of the at least one recipient.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
receiving, by a services application of a computing system and from a customer device, bill information for one or more invoices of at least one recipient to be paid by a customer associated with the customer device;
sending, by the services application of the computing system and to a credit account number server, a request for generation of one or more virtual credit card numbers associated with an originating account of the customer for the one or more invoices;
identifying, by the services application of the computing system, a batch of invoices of a particular recipient from among the one or more invoices that have a recipient identifier of the particular recipient;
determining, by the services application of the computing system, a preferred payment file format of the particular recipient;
automatically creating, by the services application of the computing system, a batch payment file in the preferred payment file format of the particular recipient, the batch payment file including the virtual credit card numbers and payment details for the batch of invoices of the particular recipient;
in response to a request by the services application, transmitting, by a secure document delivery (SDD) service of the computing system, a secure electronic mail message including the batch payment file in the preferred payment file format for payment of the batch of invoices without exposing the originating account of the customer to the particular recipient;
identifying, by the services application of the computing system, an issue with a payment of at least one invoice of the one or more invoices, the issue to be repaired prior to processing the payment, wherein identifying the issue comprises, in response to a call to an electronic mail web service:
determining, by the SSD service of the computing system, a failed delivery status of the secure electronic mail message including the batch payment file, and
identifying, by the SSD service of the computing system, a reject reason for the failed delivery status of the secure electronic mail message;
generating, by a presentation application of the computing system, data representative of a dashboard user interface for display on the customer device, the dashboard user interface presenting one or more pending payments of the one or more invoices, wherein generating the data representative of the dashboard user interface includes generating at least one indication of the issue with the payment of the at least one invoice, and wherein generating the at least one indication of the issue with the payment of the at least one invoice includes mapping the reject reason for the failed delivery status of the secure electronic mail message including the batch payment file to a user-readable repair reason description for display to the customer associated with the customer device via the dashboard user interface;
receiving, by the presentation application of the computing system, input from the customer associated with the customer device via the dashboard user interface to repair the payment of the at least one invoice; and
in response to a subsequent request by the services application, transmitting, by the SDD service of the computing system, a subsequent secure electronic mail message including the virtual credit card number and payment details for the at least one invoice for the payment of the at least one invoice.

2. The method of claim 1, wherein the originating account of the customer comprises a commercial credit card account, a business checking account, or a line of credit account.

3. The method of claim 1, wherein the request for generation of the virtual credit card number for a respective invoice comprises a request for generation of a single-use number that is valid for only one payment of an exact amount of the respective invoice.

4. The method of claim 1, wherein the request for generation of the virtual credit card number for a respective invoice comprises a request for generation of a multi-use number that is valid for one of:
two or more payments, each up to a predetermined amount, of an exact amount of the respective invoice; or
one payment of the exact amount of the respective invoice and at least one other payment of another invoice up to an exact amount of the another invoice.

5. The method of claim 1, wherein the request for generation of the virtual credit card number for a respective invoice comprises a request for generation of a virtual credit card number that is only valid for an exact amount of the respective invoice, during a specific date range, and for a specific recipient associated with the respective invoice.

6. (canceled)

7. The method of claim 1, further comprising, prior to transmitting the secure electronic mail message including the batch payment file, sending, by the computing system and to a recipient device of the particular recipient, a message that the batch payment file is available for retrieval via a secure channel.

8. The method of claim 1, wherein transmitting the secure electronic mail message including the batch payment file comprises transmitting the secure electronic mail message including the virtual credit card numbers and payment details for the batch of invoices to a recipient device of the particular recipient, wherein the recipient device processes the payment of the batch of invoices and a merchant acquirer of the particular recipient deposits funds into a bank account of the particular recipient.

9. The method of claim 1, wherein transmitting the secure electronic mail message including the batch payment file comprises:
transmitting the secure electronic mail message including the virtual credit card numbers and payment details for the batch of invoices to a merchant acquirer of the particular recipient, wherein the merchant acquirer processes the payment of the batch of invoices and deposits funds into a bank account of the particular recipient; and
sending a message to a recipient device of the particular recipient indicating that the payment has occurred.

10. (canceled)

11. The method of claim 1, wherein receiving the bill information for the one or more invoices comprises receiving the bill information from the customer device via one of a secure email or an application programming interface (API).

12. (canceled)

13. The method of claim 1,
wherein transmitting the secure electronic mail message comprises transmitting, by the SDD service of the computing system, the secure electronic mail message including the batch payment file for the payment of the batch of invoices of the particular recipient using an electronic mail address of the particular recipient;
wherein receiving the input to repair the payment of the at least one invoice comprises receiving, by the presentation application of the computing system, input from the customer associated with the customer device via the dashboard user interface to correct the electronic mail address of the particular recipient; and
wherein transmitting the subsequent secure electronic mail message comprises transmitting, by the SDD service of the computing system, the subsequent secure electronic mail message including the batch payment file for the payment of the batch of invoices using the corrected electronic mail address of the particular recipient.

14. A computing system comprising:
one or more interfaces; and
one or more processors in communication with the one or more interfaces, the one or more processors configured to:
receive, by a services application of the computing system and from a customer device, bill information for one or more invoices of at least one recipient to be paid by a customer associated with the customer device;
send, by the services application and to a credit account number server, a request for generation of one or more virtual credit card numbers associated with an originating account of the customer for the one or more invoices;
identify, by the services application of the computing system, a batch of invoices of a particular recipient from among the one or more invoices that have a recipient identifier of the particular recipient;
determine, by the services application of the computing system, a preferred payment file format of the particular recipient;
automatically creae, by the services application of the computing system, a batch payment file in the preferred payment file format of the particular recipient, the batch payment file including the virtual credit card numbers and payment details for the batch of invoices of the particular recipient;
in response to a request by the services application, transmit, by a secure document delivery (SDD) service of the computing system, a secure electronic mail message including the batch payment file in the preferred payment file format for payment of the batch of invoices without exposing the originating account of the customer to the particular recipient;
identify, by the services application, an issue with a payment of at least one invoice of the one or more invoices, the issue to be repaired prior to processing the payment, wherein to identify the issue the one or more processors are configured to, in response to a call to an electronic mail web service:
determine, by the SSD service, a failed delivery status of the secure electronic mail message including the batch payment file, and
identify, by the SSD service, a reject reason for the failed delivery status of the secure electronic mail message;
generate, by a presentation application of the computing system, data representative of a dashboard user interface for display on the customer device, the dashboard user interface presenting one or more pending payments of the one or more invoices, wherein generating the data representative of the dashboard user interface includes generating at least one indication of the issue with the payment of the at least one invoice, and wherein to generate the at least one indication of the issue with the payment of the at least one invoice, the one or more processors are configured to map the reject reason for the failed delivery status of the secure electronic mail message including the batch payment file to a user-readable repair reason description for display to the customer associated with the customer device via the dashboard user interface;
receive, by the presentation application, input from the customer associated with the customer device via the dashboard user interface to repair the payment of the at least one invoice; and
in response to a subsequent request by the services application, transmit, by the SDD service, a subsequent secure electronic mail message including the virtual credit card number and payment details for the at least one invoice for the payment of the at least one invoice.

15. (canceled)

16. The computing system of claim 14, wherein the one or more processors are configured to, prior to transmitting the secure electronic mail message including the batch payment file, send, to a recipient device of the particular recipient, a message that the batch payment file is available for retrieval via a secure channel.

17. The computing system of claim 14, wherein, to transmit the secure electronic mail message including the batch payment file, the one or more processors are configured to transmit the secure electronic mail message including the virtual credit card numbers and payment details for the bath of invoices to a recipient device of the particular recipient, wherein the recipient device processes the payment of the batch of invoices and a merchant acquirer of the particular recipient deposits funds into a bank account of the particular recipient.

18. The computing system of claim 14, wherein, to transmit the secure electronic mail message including the batch payment file, the one or more processors are configured to:
transmit the secure electronic mail message including the virtual credit card numbers and payment details for the batch of invoices to a merchant acquirer of the particular recipient, wherein the merchant acquirer processes the payment of the batch of invoices and deposits funds a bank account of the particular recipient; and
send a message to a recipient device of the particular recipient indicating that the payment has occurred.

19. (canceled)

20. A non-transitory computer-readable storage medium comprising instructions that, when executed, cause one or more processors of a computing system to:
receive, by a services application of the computing system and from a customer device, bill information for one or more invoices of at least one recipient to be paid by a customer associated with the customer device;
send, by the services application and to a credit account number server, a request for generation of one or more virtual credit card numbers associated with an originating account of the customer for the one or more invoices; and
identify, by the services application of the computing system, a batch of invoices of a particular recipient from among the one or more invoices that have a recipient identifier of the particular recipient;
determine, by the services application of the computing system, a preferred payment file format of the particular recipient;
automatically create, by the services application of the computing system, a batch payment file in the preferred payment file format of the particular recipient, the batch payment file including the virtual credit card numbers and payment details for the batch of invoices of the particular recipient;
in response to a request by the services application, transmit, by a secure document delivery (SDD) service of the computing system, a secure electronic mail message including the batch payment file in the preferred payment file format for payment of the batch of invoices without exposing the originating account of the customer to the particular recipient;
identify, by the services application, an issue with a payment of at least one invoice of the one or more invoices, the issue to be repaired prior to processing the payment, wherein to identify the issue the instructions cause the one or more processors to, in response to a call to an electronic mail web service:
determine, by the SSD service, a failed delivery status of the secure electronic mail message including the batch payment file, and
identify, by the SSD service, a reject reason for the failed delivery status of the secure electronic mail message;
generate, by a presentation application of the computing system, data representative of a dashboard user interface for display on the customer device, the dashboard user interface presenting one or more pending payments of the one or more invoices, wherein generating the data representative of the dashboard user interface includes generating at least one indication of the issue with the payment of the at least one invoice, and wherein to generate the at least one indication of the issue with the payment of the at least one invoice, the instructions cause the one or more processor to map the reject reason for the failed delivery status of the secure electronic mail message including the batch payment file to a user-readable repair reason description for display to the customer associated with the customer device via the dashboard user interface;
receive, by the presentation application, input from the customer associated with the customer device via the dashboard user interface to repair the payment of the at least one invoice; and
in response to a subsequent request by the services application, transmit, by the SDD service, a subsequent secure electronic mail message including the virtual credit card number and payment details for the at least one invoice for the payment of the at least one invoice.

21. (canceled)

22. The computing system of claim 14,
wherein to transmit the more secure electronic mail message, the one or more processors are configured to transmit, by the SDD service of the computing system, the secure electronic mail message including the batch payment file for the payment of the batch of invoices of the particular recipient using an electronic mail address of the particular recipient;
wherein to receive the input to repair the payment of the at least one invoice, the one or more processors are configured to receive, by the presentation application of the computing system, input from the customer associated with the customer device via the dashboard user interface to correct the electronic mail address of the particular recipient; and
wherein to transmit the subsequent secure electronic mail message, the one or more processors are configured to transmit, by the SDD service of the computing system, the subsequent secure electronic mail message including the batch payment file for the payment of the batch of invoices using the corrected electronic mail address of the particular recipient.
